(19) United States
(12) Patent Application Publication
(10) Pub. No.: US 2026/0268236 A1
(43) Pub. Date: Sep. 10, 2026

(54) BOOKING SYSTEM AND BOOKING METHOD

(71) Applicant: CURATORS TRAVEL CO., LTD., Taipei City (TW)

(72) Inventors: HUNG-TSO CHEN, Taipei City (TW); PIN-HAN CHEN, Taipei City (TW); JUI-HUNG TSENG, Taipei (TW)

(21) Appl. No.: 19/069,261

(22) Filed: Mar. 4, 2025

(51) Int. Cl. G06Q 10/02; G06Q 50/12

(52) U.S. Cl. CPC G06Q 10/02; G06Q 50/12

(57) ABSTRACT

The present invention provides a booking system and method with a price tracking function. The method includes providing a first booking price for a hotel room to a user device and generating a first hotel booking order in response to a booking request. When a tracking request is received, the system obtains a second booking price from a GDS server after the first booking order is generated. The second price is compared with the first price. If the second price is lower, a notification is sent to a middleware module, which generates and presents lower price information to the user device.

### BACKGROUND OF THE INVENTION

### Field of the Invention

The present invention relates to technology for a remote hotel room booking system. More particularly, the present invention relates to a booking system and method adapted for tracking the price of a hotel room ordered by a user and reordering the hotel room if the price decreases.

### Description of the Related Art

The booking systems in the conventional art allow users to reserve hotel rooms through an online platform. These systems typically provide a convenient and efficient way for customers to browse available rooms, check availability, and secure bookings by selecting desired dates and room types. Such platforms have become widely used in the hospitality industry, offering travelers flexibility in choosing accommodations and making real-time reservations without the need for direct contact with the hotel.

However, the booking systems in the conventional art do not offer functionality to track price fluctuations after a reservation has been made. While these systems allow users to secure bookings, they do not provide a means for consumers to monitor price changes or receive notifications if a lower rate becomes available for the same room type. As a result, users face difficulty in obtaining accurate, up-to-date information on price reductions, and manually tracking such changes becomes a repetitive and cumbersome task. This lack of price tracking functionality leaves consumers unable to take advantage of potential savings, even if a more affordable rate is offered later.

### BRIEF SUMMARY OF THE INVENTION

In view of this, the embodiment of the present invention is to provide a booking system and a booking method, adapted for automatically notifying the price of a hotel room ordered by a user if the price decreases when user enable the tracking function.

Another objective of the preferred embodiment of the present invention is to provide a booking system and method adapted for reordering the hotel room at a lower price when the user enables the reorder function upon receiving a notification of a price decrease for the hotel room.

In view of this, a preferred embodiment of the present invention provides a booking system for hotel reservations. The booking system includes a website server, a middleware server, a scanning server, a global distribution system (GDS) server. The website server is configured to provide an initial booking price for a hotel room. The middleware server is configured to generate a first hotel booking order, which includes the initial booking price, in response to a first booking request made by a user device. The GDS server provides a secondary booking price for the hotel room once the booking order is created. The scanning server receives a tracking request from the user device, retrieves the secondary booking price from the GDS server, and compares it with the initial booking price. If the secondary price is lower than the initial price, the scanning server sends a notification to the middleware server. In response to the notification, the middleware server generates and presents to the user device lower price information associated with the secondary booking price.

Another preferred embodiment of the present invention provides a booking system adapted for price-quoting and booking from a GDS server. The booking system includes a website module, a middleware module and a scanning module. The website module is configured to provide an initial booking price for a hotel room. The middleware module is configured to generate a first hotel booking order that includes the initial booking price in response to a first booking request made by a user device. The scanning module receives a tracking request from the user device, retrieves a secondary booking price for the hotel room from the GDS server after the first booking order is created, and compares the secondary price with the initial price. If the secondary price is lower, the scanning module sends a notification to the middleware module. In response, the middleware module generates and presents lower price information related to the secondary booking price to the user device.

Another preferred embodiment of the present invention provides a method for booking a hotel room, comprising: providing a first booking price for the hotel room to a user device; generating a first hotel booking order including the first booking price in response to a first booking request from the user device by a middleware module; wherein, when a tracking request from the user device is received by a scanning module, the method further comprises: obtaining a second booking price for the hotel room from a GDS server after the first booking order is generated; comparing the second booking price with the first booking price to determine if the second booking price is lower; when the second booking price is lower than the first booking price, the method further comprising: sending a notification to the middleware module; and generating lower price information associated with the second booking price in response to the notification such that the lower price information is presented to the user device.

The preferred embodiment of the present invention proposes a hotel booking system and method that improves the user experience by offering dynamic price tracking and adjustments. The system begins by providing an initial booking price for a hotel room to a user device and generating a hotel booking order based on that price. When the user initiates a tracking request, a scanning module compares the initial price with a secondary price obtained from a GDS server. If the second price is lower, a notification is sent to the middleware module, which then generates and presents updated lower price information to the user. This approach allows for real-time price adjustments, ensuring users are always presented with the most competitive rates. The present invention not only provides accurate and timely pricing but also maximizes user satisfaction and booking efficiency, ultimately benefiting both consumers and service providers.

The above-mentioned and other objects, features and advantages of the present invention will become more apparent from the following detailed descriptions of preferred embodiments thereof taken in conjunction with the accompanying drawings.

### BRIEF DESCRIPTION OF THE SEVERAL VIEWS OF THE DRAWINGS

The accompanying drawings provided are intended to further assist people having ordinary skill in the art in understanding the present invention, and are incorporated as part of the description that forms the specification of the invention. The drawings illustrate exemplary embodiments of the invention and are used together with the description to explain the principles of the invention.

FIG. 1 illustrates a schematic diagram depicting a booking system according to an exemplary embodiment of the present invention.

FIG. 2 illustrates a system block diagram depicting a booking system according to an exemplary embodiment of the present invention.

FIG. 3 illustrates a network process flow diagram depicting a booking process through the booking system according to an exemplary embodiment of the present invention.

FIG. 4 illustrates a network process flow diagram depicting a price tracking process through the booking system according to an exemplary embodiment of the present invention.

FIG. 5 illustrates a tracking table for a price tracking process through the booking system according to an exemplary embodiment of the present invention.

FIG. 6 illustrates a network process flow diagram depicting a rebooking process through the booking system according to an exemplary embodiment of the present invention.

FIG. 7 illustrates a flowchart depicting a booking method including the price tracking function according to an exemplary embodiment of the present invention.

FIG. 8 illustrates a flowchart depicting the sub-steps between the step S703 and the step S704 of the booking method according to an exemplary embodiment of the present invention.

FIG. 9 illustrates a flowchart depicting the additional steps for rebooking at a lower price in the booking method according to an exemplary embodiment of the present invention.

### DETAILED DESCRIPTION OF THE INVENTION

In the following detailed description of the exemplary embodiment of the present invention, the exemplary embodiment will be illustrated in the accompanying drawings. Where possible, the same reference numerals are used in the drawings and the description to refer to the same or similar components. Furthermore, the exemplary embodiments presented are merely implementations of the design concept of the present invention, and the examples provided below are not intended to limit the scope of the invention.

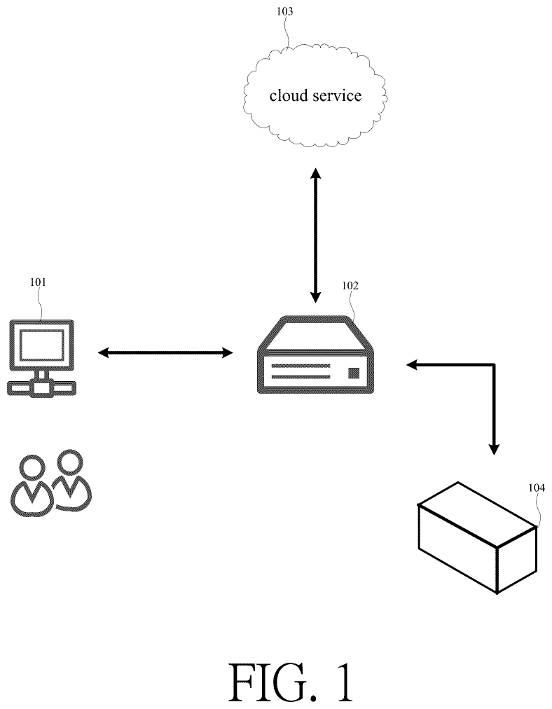

FIG. 1 illustrates a schematic diagram depicting a booking system according to an exemplary embodiment of the present invention. Referring to FIG. 1, in this embodiment, a user can use the user device 101, such as personal computer, mobile phone or tablet computer, to connect to the booking system via the internet to book a hotel room. The booking system includes at least one host device 102 and a cloud service provider 103. The host device 102 may include a plurality of servers and is used to connect to the global distribution system (GDS) server 104 via the internet. The host device 102 may also be one of the services provided by the cloud service provider 103.

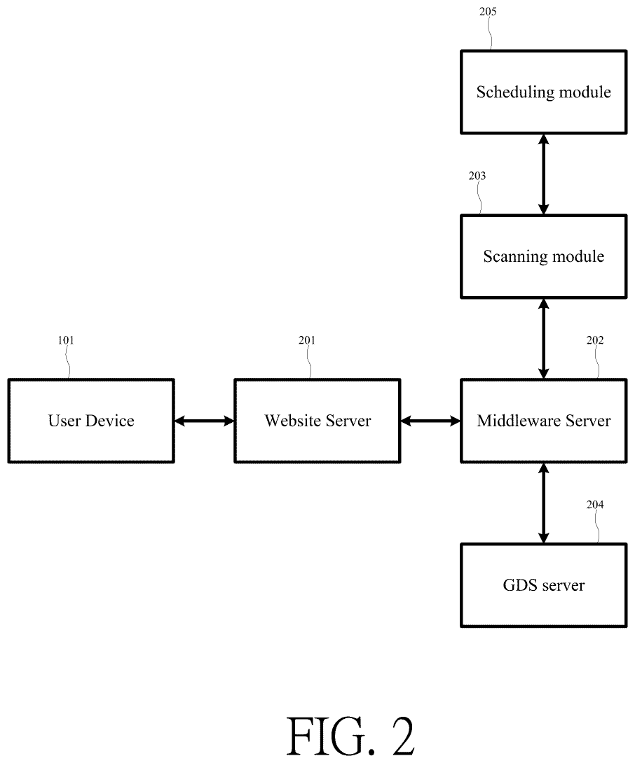

FIG. 2 illustrates a system block diagram depicting a booking system according to an exemplary embodiment of the present invention. Referring to FIG. 2, the booking system includes a website server 201, a middleware server 202, a scanning module 203 and a scheduling module 205. In order to help people having ordinary skill in the art understand the spirit of the present invention, a GDS server 204 is also illustrated in FIG. 2. The website server 201, with the website module installed, is used for providing a website service, such as a sign-in interface for user to create a user account, a login interface for multiple user accounts to log in, and an interface for user to search and book hotel rooms. Therefore, the website server 201 is generally considered a front-end platform. The middleware server 202 is used for the connection between the website server 201, the scanning module 203, the GDS server 204 and the scheduling module 205, and may be implemented as an application program interface (API) server. The GDS server 204 is generally a computerized network system owned or operated by a company that enables transactions between travel industry service providers, mainly hotels and travel agencies. The GDS server 204 mainly uses real-time inventory (e.g., the number of hotel rooms available, or the number of cars available) from the service providers. The scanning module 203 is used for tracking price. The scheduling module 205 is for arrangement of the price tracking schedule. In this embodiment, the servers 201, 202, the modules 203 and 205 may be implemented at the host device 102 and/or the cloud service provider 103.

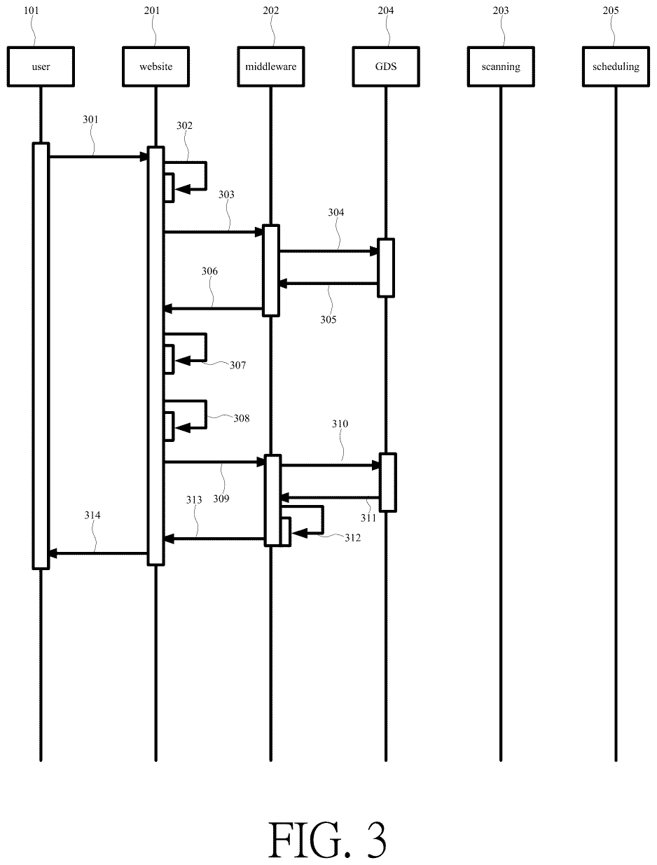

FIG. 3 illustrates a network process flow diagram depicting a booking process through the booking system according to an exemplary embodiment of the present invention. Referring to FIG. 3, first, in the process 301, a user logs into the booking system and starts searching for a hotel room. Next, in the process 302, the website server 201 initiates the search process in response to the input condition provided by the user's operation, such as date, location, etc. In the process 303, the website server 201 connects to the middleware server 202. In the process 304, the middleware server 202 inquiries about the available rooms, their prices and service plans from the GDS server 204 via an application program interface (API). In the process 305, the GDS server 204 returns the available rooms, their prices and service plans to the middleware server 202. In the process 306, the website server 201 receives the list of available rooms, their prices and service plans which are organized by the website server 201 and displayed on the user device 101, allowing the user to browse and select a hotel room from the list.

When user uses the user device 101 to select a hotel room from the list provided by the website server 201, the process 307 is performed, wherein the website server 201 provides the details of the hotel room, such as room size, interior photos of the room, check-in time, check-out time, whether lunch and dinner are included, etc. When the user decides to book a hotel room, and selects a book option, such as touch or click the book button, the process 308 is performed, wherein the website server 201 provides a booking form for the user to fill in check-in information, such as name, passport number, credit card information, etc. After the user fills in the booking form and selects the confirm link, such as touching or clicking the confirm button, the order establishment process 309 is performed, wherein the website server 201 sends the information of the booking form to the middleware server 202.

In the order creation process 310, the middleware server 202 orders the hotel room from the GDS server 204 based on the information in the booking form sent by the website server 201. In the process 311, the order is created by the GDS server 204 and returned to the middleware server 202. After that, the middleware server 202 performs the process 312 to create an order information. In the process 313, the middleware server 202 sends the order information to the website server 201 so that the user can use the user device to connect to the website server 201 and view the booking information for the hotel room. In the process 314, the website server 201 provides the order information including the first booking price to notify the user, such as through email and/or by presenting it on the website associated with the user account.

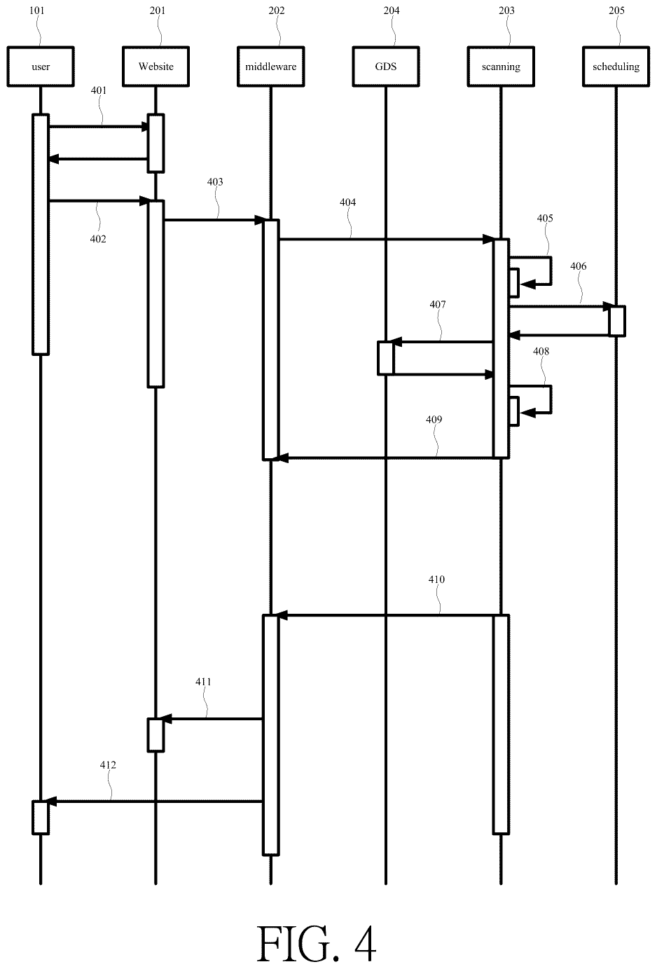

FIG. 4 illustrates a network process flow diagram depicting a price tracking process through the booking system according to an exemplary embodiment of the present invention. Referring to FIG. 4, in the process 401, user can log into the website server 201 using the user account to check the order for the hotel room. On the order confirmation page, under certain booking conditions, a price tracking button associated with each hotel room order that the user has booked would be generated and presented. Generally, this booking condition is when the free refund period for the hotel room is still valid, in which case the price tracking button will be displayed. Additionally, in this embodiment, user accounts are divided into multiple levels, with each level having a different quota. The number of quotas for each account determines how many price tracking functions can be performed by the user account.

For example, the levels of the user account may be divided into three types: standard user, premium user, and elite user. When the user account is a standard user, the quota is 2, which means that only two price tracking functions for hotel rooms can be enabled at the same time by the user account. When the user account is a premium user, the quota is 4, which means that four price tracking functions for hotel rooms can be enabled at the same time by the user account. When the user account is an elite user, the quota may be unlimited, which means that the user account can enable an unlimited number of price tracking functions for hotel rooms at the same time. In this embodiment, the level of the user's account will increase with the frequency of use of the booking system.

In the process 402, user enables the price tracking function using the user device 101. In the process 403, the website server 201 notifies the middleware server 202 to perform the price tracking function. In the process 404, the middleware server 202 uses an API to notify the scanning module 203 to establish the price tracking for the hotel room. Afterward, the scanning module 203 checks the quota of the user account in the process 405. When the quota of the user account is greater than or equal to a preset number, which means the quota is sufficient, the scanning server performs the process 406 to establish a schedule for the price tracking. Furthermore, the scanning module 203 also deducts the quota associated with the user account by a preset value. For example, when the user account is a standard user, the quota is 2. If the quota of the user account is deducted by 1, it means the processes 402 to 409 can only be performed once more.

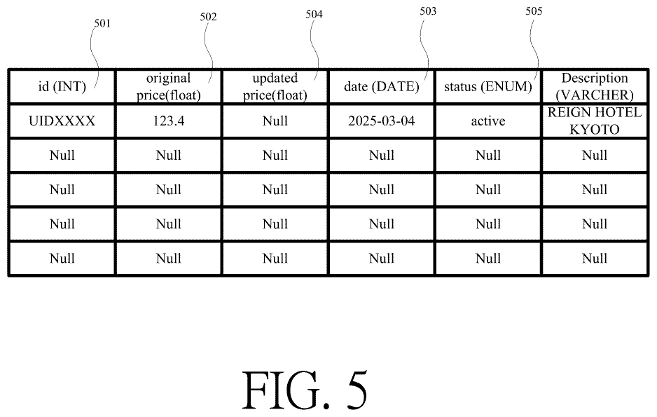

FIG. 5 illustrates a tracking table for a price tracking process through the booking system according to an exemplary embodiment of the present invention. Referring to FIG. 5, the tracking table in this embodiment may take the form of a Structured Query Language (SQL) table, which includes a user ID field 501, an original price field 502, a booking date field 503, an updated price field 504, and a status field 505. The user ID field 501 is for storing a unique ID of the user account. The original price field 502 is for storing the first booking price of the hotel room. The booking date field 503 is for storing the booking date of the hotel room. The status field 505 in this embodiment includes at least two state, active state and inactive state. In process 406, the scheduling module 205 fills in a column of the tracking table with the information corresponding to the hotel room booked by the user in the above fields and sets the status field 505 of the column to “active state”.

When the column of the tracking table is established, the scanning module 203 will periodically perform the process 407 to scan the second booking price of the hotel room in the tracking table from the GDS server 204, where the status field 505 is “active state”. The price scanning period in this embodiment may be once a day. The scanned second booking price will be stored in the updated price field 504. After the process 407 is performed, the comparing process 408 is performed, the scanning module 203 compares the first booking price in the original price field 502 with the second booking price in the updated price field 504. And then, the process 409 is performed to notify the second booking price to the middleware server 202. And then, the middleware server 202 records the second booking price to a database.

If the second booking price in the updated price field 504 is lower than the first booking price in the original price field 502, the process 410 is performed, where the scanning module 203 sends a notification to the middleware server 202 to issue a price reduction notification. In the process 411, the website server 201 fetches data from the middleware server 202 via HTTP to display price reduction information so that the price reduction information is presented to user device 101 when user logs in using the user device 101. The middleware server 202 then performs the process 412 to generate an email notification presenting the lower price information associated with the second booking price. In this embodiment, the email notification further includes a one-click rebooking link that allows the user to rebook the hotel room at the lower price using the user account through the user device 101.

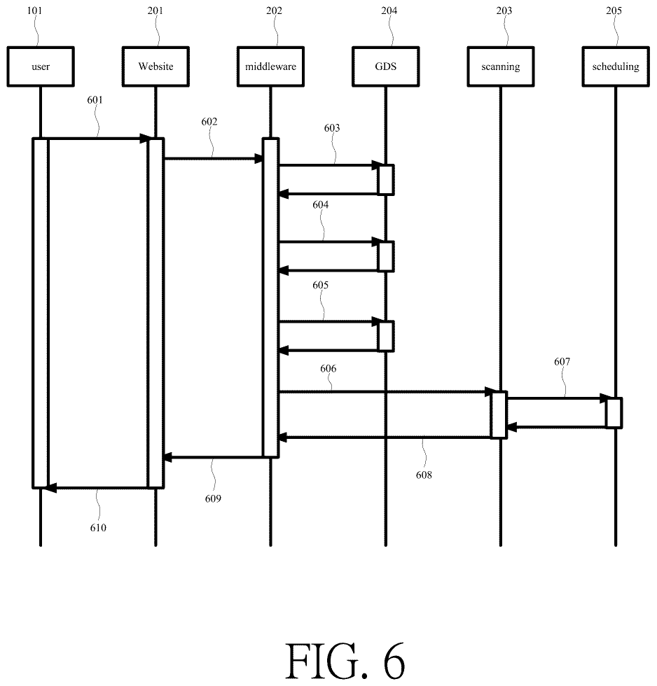

FIG. 6 illustrates a network process flow diagram depicting a rebooking process through the booking system according to an exemplary embodiment of the present invention. Referring to FIG. 6, when user clicks or touches the button of the one-click rebooking link on the user device 101, the rebook process 601 is performed. And then, the website server 201 performs process 602 to notify the middleware server 202 to perform a sequence process of the rebooking processes based on the original booking information. In the process 603, the middleware server 202 rescans the price of the hotel room from the GDS server 204 and then the GDS server 204 responds with the price to the middleware server 202. In the order creation process 604, the middleware server 202 orders the same hotel room from the GDS server 204 based on the previous information in the booking form so that the user does not need to re-enter the information. After the rebooking process 604 is completed, the process 605 is performed, where the middleware server 202 performs the cancelation of the previous reservation of the original hotel room with the GDS server 204. And then, the process 606 is performed, wherein the middleware server 202 disables the price tracking function of the scanning module 203 when a lower price is found.

In the process 607, the scanning module 203 changes the status field 505 of the tracking table on the scheduling module 205 to the “inactive state”. After the status field 505 is set to the “inactive state”, the scanning module 203 returns the quota to the user account. For example, if the quota of the user account is reduced to 1, and since the status field 505 is set to the “inactive state”, the quota of the user account is refunded, bringing the quota of the user account back to 2. In the process 608, the scanning module 203 reports the results to the middleware server 202, such as the rebooking result for the hotel room, the cancellation result for the previously ordered hotel room and the cancellation of the price tracking. In the process 609, the middleware server 202 updates the website server 201 so that the results can be presented on the website server 201 when the user logs in with the user account. In the process 610, the results are presented on the user device 101 when the user logs in with the user account.

The above embodiment is performed under the assumption that the process runs smoothly. However, during the price tracking process, there are still some situations where processes 606 to 607 may be prematurely performed. For example, if the hotel room exceeds the free refund period, causing the cancellation price plus the rebooking price to be higher than the original booking price, processes 606 to 607 will be prematurely performed. Alternatively, if the user cancels the price tracking function, processes 606 to 607 will also be prematurely performed. People having ordinary skill in the art should understand that different situations require different network processes. Therefore, the detailed description is omitted.

Moreover, in the above embodiment, the website server 201, the middleware server 202, the scanning module 203, and the scheduling module 205 can all be integrated into a single host computer. As hardware has improved, multitasking can be performed on newer hardware, or virtualization technology can also be used. Therefore, the present invention does not limit the servers to using different hardware. Additionally, the above scanning module 203 the scheduling module 205 can also be respectively implemented as the scanning server 203 and the scheduling server 204 to independently operate the functions of the scanning module 203 and the scheduling module 205. Furthermore, the above servers 201, 202, and the modules 203, 204 can also be implemented on a single multifunction server. In other words, the website server 201, the middleware server 202, the scanning module 203, and the scheduling module 205 can each be implemented as modules within a single server, such as the website module 201, the middleware module 202, the scanning module 203, and the scheduling module 205. Therefore, the present invention is not limited thereto. Furthermore, the above servers or modules can be implemented as either software modules or hardware modules. The present invention is also not limited thereto.

Furthermore, in the above embodiment, the level of the user account, the quota, the scheduling module 205, the tracking table in FIG. 5, one-click rebooking link and the associated buttons are preferable embodiments of the present invention. People having ordinary skill in the art should know that, depending on the actual application, the above embodiments can be modified, adopted, or not adopted, etc. Additionally, the processes of the above embodiments can be increased or decreased based on actual needs, such as for security reasons or to improve processing efficiency. Further, the form of the tracking table in FIG. 5 also can be modified according to the different designs. Thus, the present invention is not limited thereto.

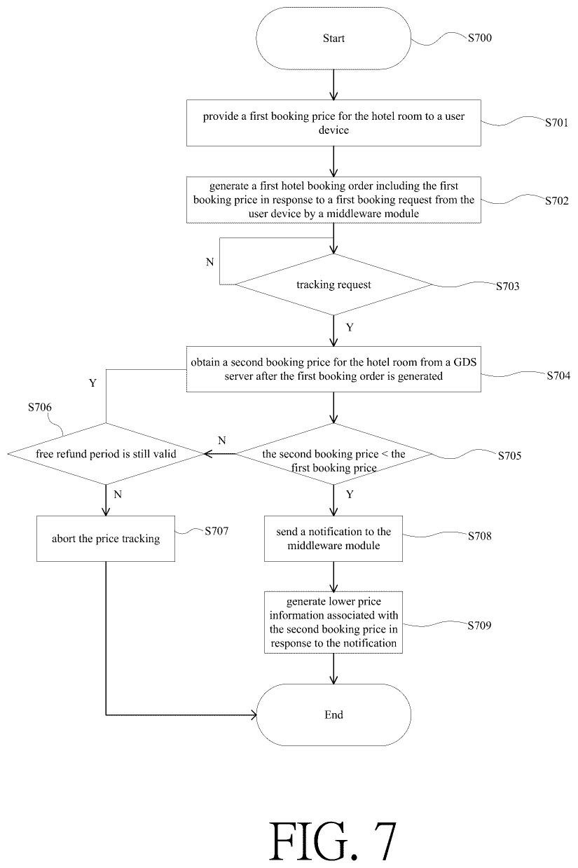

From the above embodiments, a booking method can be summarized. FIG. 7 illustrates a flowchart depicting a booking method with the price tracking function according to an exemplary embodiment of the present invention. Referring to FIG. 7, the booking method includes the steps of:

In step S700, the method starts.

In step S701, a first booking price for the hotel room to a user device is provided. In the above embodiment, the website server/module provides the first booking price after the hotel room is booked by user in the process 314.

In step S702, a first hotel booking order including the first booking price is generated by a middleware module in response to a first booking request from the user device. In the above embodiment, the middleware server 202 performs the processes 310 to 312 to create an order information including the first booking price.

In step S703, it is determined whether a tracking request from the user device is received. If the tracking request is not received, return to the step S703. If the tracking request is received, perform the step S704.

In step S704, a second booking price for the hotel room from a GDS server is obtained after the first booking order is generated. In the above embodiment, the scanning module/server 203 will periodically perform the process 407 to scan the second booking price of the hotel room on the tracking table from the GDS server 204.

In step S705, it is determined whether the second booking price is lower than the first booking price. The step S705 is periodically performed. In this embodiment, the middleware server 202 compares the booking price from the data base with the new price from the GDS server 204 and records them. When the second booking price is higher than the first booking price, the step S706 is performed. When the second booking price is lower than the first booking price, the step S708 is performed.

In step S706, it is determined whether the free refund period of the ordered hotel room is still valid. When the free refund period is still valid, go back to the step S704. When the free refund period is expired, the step S707 is performed.

In step S707, the price tracking is aborted.

In step S708, a notification to the middleware module is sent. In the above embodiment, when the second booking price is lower than the first booking price, the process 410 is performed, the scanning module/server 203 sends a notification to the middleware server 202 to issue a price reduction notification.

In step S709, the lower price information associated with the second booking price in response to the notification is generated. In the above embodiment, according to the processes 410 to 412, the lower price information can be presented to the user device 101.

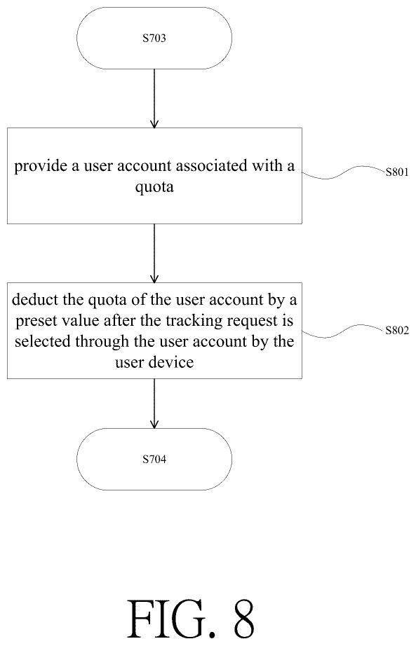

FIG. 8 illustrates a flowchart depicting the sub-steps between the step S703 and the step S704 of the booking method according to an exemplary embodiment of the present invention. The sub-steps between the step S703 and the step S704 of the booking method further includes the steps of:

In step S801, a user account associated with a quota is provided, which limits a number of times for performing tracking request thorough the user account.

In step S802, the quota of the user account is deducted by a preset value after the tracking request is selected through the user account by the user device. Since the embodiment in FIG. 4 and the processes 401 to 405 are described, the detailed description is omitted.

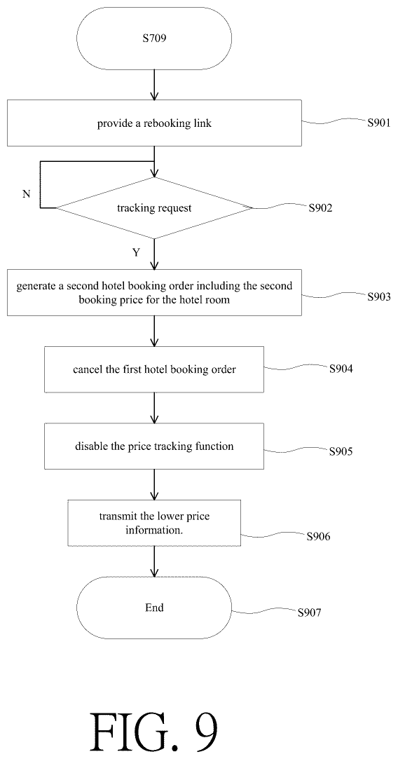

FIG. 9 illustrates a flowchart depicting the additional steps for rebooking at a lower price in the booking method according to an exemplary embodiment of the present invention. Referring to FIG. 9, the booking method includes the following steps:

In step S901, a rebooking link is provided in associated with the lower price information. In the above embodiment of process 412, the email notification further includes a one-click rebooking link that allows the user to rebook the hotel room at the lower price using the user account through the user device 101. Besides, in a preferred embodiment, a pricing tracking information page with the rebooking link can also be provided on the website. The present invention is not limited thereto.

In step S902, it is determined whether the rebooking link is selected or not. When the rebooking link is selected, the step S903 is performed. When the rebooking link is not selected, go back to the step S902.

In step S903, a second hotel booking order including the second booking price for the hotel room is generated. When the rebooking link is selected, a second booking request is generated by the user device. Therefore, the processes 601 to 604 are performed as the above embodiment.

In step S904, the first hotel booking order is canceled after the second hotel booking order is generated.

In step S905, the price tracking function is disabled. As the abovementioned embodiment, the processes 606 to 608 are performed. The price tracking function is disabled by the middleware module/server 202.

In step S906, the lower price information is transmitted to the website server so that the website server/module present the lower price information when user logs in the website server/module.

In step S907, the method end.

In summary, the preferred embodiment of the present invention proposes a hotel booking system and method that significantly improves the user experience by integrating dynamic price tracking and adjustments. The system begins by providing an initial booking price for a hotel room to a user device and generating a hotel booking order based on that price. When the user initiates a tracking request, a scanning module compares the initial price with a secondary price obtained from a GDS server. If the second price is lower, a notification is sent to the middleware module, which then generates and presents updated lower price information to the user. This approach allows for real-time price adjustments, ensuring users are always presented with the most competitive rates. The system is flexible, allowing for the integration of multiple servers into a single multifunctional server. In the preferred embodiment, one-click rebooking, and dynamic quota management is also implemented. The tracking and rebooking capabilities provides users with a more convenient, cost-effective, and user-friendly platform for managing hotel reservations. Thus, the preferred embodiment of the present invention maximizes user satisfaction and booking efficiency.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

1. A booking system for booking a hotel room, comprising:
a website server configured to provide a first booking price for the hotel room and generate a user account for a user device to log in to the website server;
a middleware server configured to generate a first hotel booking order including the first booking price for the hotel room in response to a first booking request generated by the user device, wherein the user account is associated with a quota that limits a number of times for the user device to generate the tracking request for a predetermined number of hotel booking orders including the first hotel booking order;
a global distribution system (GDS) server configured to provide a second booking price for the hotel room after the first hotel booking order is generated; and
a scanning server configured to:
receive a tracking request generated by the user device;
check whether the quota is greater than or equal to a preset number;
deduct the quota by a preset value after the tracking request is generated by the user device;
track, in response to checking that the quota is greater than or equal to the preset number, the second booking price from the GDS server;
obtain the second booking price from the GDS server;
determine whether the second booking price is lower than the first booking price; and
transmit a notification to the middleware server after determining that the second booking price is lower than the first booking price;
wherein the middleware server is further configured to generate, in response to the notification, lower price information associated with the second booking price to be presented to the user device.

2. The booking system according to claim 1, wherein:
the lower price information includes a rebooking link for the user device to be selected; and
the middleware server is further configured to:
generate a second hotel booking order including the second booking price for the hotel room in response to a second booking request that is generated by the user device in response to selection of the rebooking link; and
cancel the first hotel booking order after the second hotel booking order is generated.

3. (canceled)

4. (canceled)

5. The booking system according to claim 2, wherein:
the lower price information is transmitted to the website server;
the website server is further configured to present the lower price information to the user device; and
the rebooking link is selected by the user device in the website server.

6. The booking system according to claim 1, wherein:
the middleware server is further configured to generate a message associated with the lower price information and transmit the message to the user device.

7. The booking system according to claim 2, further comprising:
a scheduling server configured to create a scanning schedule in response to the tracking request, wherein the scanning server is further configured to scan the second booking price from the GDS server based on the scanning schedule to obtain the second booking price.

8. The booking system according to claim 7, wherein:
the scheduling server is further configured to cancel the scanning schedule after the middleware server cancel the first hotel booking order.

9. A booking system for booking a hotel room, comprising:
a website module configured to provide a first booking price for the hotel room and generate a user account for a user device to log in to a website server with the website module installed therein;
a middleware module configured to generate a first hotel booking order including the first booking price for the hotel room in response to a first booking request generated by the user device, wherein the user account is associated with a quota that limits a number of times for the user device to generate the tracking request for a predetermined number of hotel booking orders including the first hotel booking order; and
a scanning module configured to:
receive a tracking request generated by the user device;
check whether the quota is greater than or equal to a preset number;
deduct the quota by a preset value after the tracking request is generated by the user device;
track, in response to checking that the quota is greater than or equal to the preset number, a second booking price from a global distribution system (GDS) server;
obtain the second booking price for the hotel room from the GDS server;
determine whether the second booking price is lower than the first booking price; and
transmit a notification to the middleware module after determining that the second booking price is lower than the first booking price;
wherein the middleware module is further configured to generate, in response to the notification, lower price information associated with the second booking price to be presented to the user device.

10. The booking system according to claim 9, wherein:
the lower price information includes a rebooking link for the user device to be selected; and
the middleware module is further configured to:
generate a second hotel booking order including the second booking price for the hotel room in response to a second booking request generated by the user device in response to selection of the rebooking link; and
cancel the first hotel booking order after the second hotel booking order is generated.

11. (canceled)

12. The booking system according to claim 10, wherein:
the lower price information is transmitted to the website module;
the website module is further configured to present the lower price information to the user device; and
the rebooking link is selected by the user device in the website module.

13. The booking system according to claim 9, wherein:
the middleware module is further configured to generate a message associated with the lower price information and transmit the message to the user device.

14. The booking system according to claim 10, further comprising:
a scheduling module configured to create a scanning schedule in response to the tracking request, wherein the scanning module is further configured to scan the second booking price from the GDS server based on the scanning schedule to obtain the second booking price, wherein the scheduling module is further configured to cancel the scanning schedule after the middleware module cancel the first hotel booking order.

15. A booking method for booking a hotel room, comprising:
providing, by a website server, a first booking price for the hotel room and generating a user account for a user device to log in to the website server;
generating a first hotel booking order including the first booking price in response to a first booking request generated by a user device;
receiving a tracking request generated by the user device, wherein the user account is associated with a quota that limits a number of times for the user device to generate the tracking request for a predetermined number of hotel booking orders including the first hotel booking order;
checking whether the quota is greater than or equal to a preset number;
deducting the quota by a preset value after the tracking request is generated by the user device;
tracking, in response to checking that the quota is greater than or equal to the preset number, a second booking price from a global distribution system (GDS) server;
obtaining the second booking price for the hotel room from the GDS server;
comparing the second booking price with the first booking price to determine if the second booking price is lower than the first booking price;
generating lower price information associated with the second booking price after determining that the second booking price is lower than the first booking price; and
presenting the lower price information to the user device.

16. The booking method according to claim 15, wherein the lower price information includes a rebooking link for the user device to be selected, and the method further comprises:
generating a second hotel booking order including the second booking price for the hotel room in response to a second booking request that is generated by the user device in response to selection of the rebooking link; and
canceling the first hotel booking order after the second hotel booking order is generated.

17. (canceled)

18. The booking method according to claim 15, further comprising:
generating a message associated with the lower price information and transmitting the message to the user device.

19. The booking method according to claim 16, further comprising:
creating a scanning schedule in response to the tracking request; and
scanning the second booking price from the GDS server based on the scanning schedule to obtain the second booking price.

20. The booking method according to claim 19, further comprising:
canceling the scanning schedule after canceling the first hotel booking order.
